(19) United States
(12) Patent Application Publication
(10) Pub. No.: US 2011/0187295 A1
(43) Pub. Date: Aug. 4, 2011

(54) ELECTRONIC APPARATUS

(75) Inventors: TING-KAI WANG, Tu-Cheng (TW); BIN LI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/958,449

(22) Filed: Dec. 2, 2010

(30) Foreign Application Priority Data
Feb. 2, 2010 (CN) 201010301110.3

(51) Int. Cl. H02P 31/00; H02K 7/14

(52) U.S. Cl. 318/15; 318/3

(57) ABSTRACT

An electronic apparatus includes a main body, a cover, a driving device, a receiving unit, and a processing unit. The cover is pivotably connected to the main body. The driving device drives the cover to rotate relative to the main body between an open position and a closed position. The receiving unit receives a control signal from an input device. The processing unit directs the driving device to rotate the cover relative to the main body between the open position and the closed position according to the control signal.

### BACKGROUND

1. Technical Field

The disclosed embodiments relate to electronic apparatuses, and more particularly to an electronic apparatus with a main body and a cover capable of rotating with respect thereto.

2. Description of Related Art

An electronic apparatus, such as a notebook, includes a cover provided with a display panel, and a main body. When the electronic apparatus is not used, the cover covers the main body to protect the display panel. When the electronic apparatus is used, the cover deploys from the main body to expose the display panel.

However, manual rotation of the cover with respect to the main body can be inconvenient.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout eight views.

FIG. 1 is a schematic diagram showing an electronic apparatus in accordance with a first exemplary embodiment.

FIG. 2 is an exploded view showing the electronic apparatus of FIG. 1.

FIG. 3 is an enlarged view showing a first driving unit and a first fixing part of the electronic apparatus of FIG. 2.

FIG. 4 is a block diagram of the electronic apparatus of FIG. 1.

FIG. 5 is a schematic diagram showing an electronic apparatus in accordance with a second exemplary embodiment.

FIG. 6 is an exploded view showing the electronic apparatus of FIG. 5.

FIG. 7 is an enlarged view showing a third driving unit and a third fixing part of the electronic apparatus of FIG. 6.

FIG. 8 is a block diagram of the electronic apparatus of FIG. 5.

### DETAILED DESCRIPTION

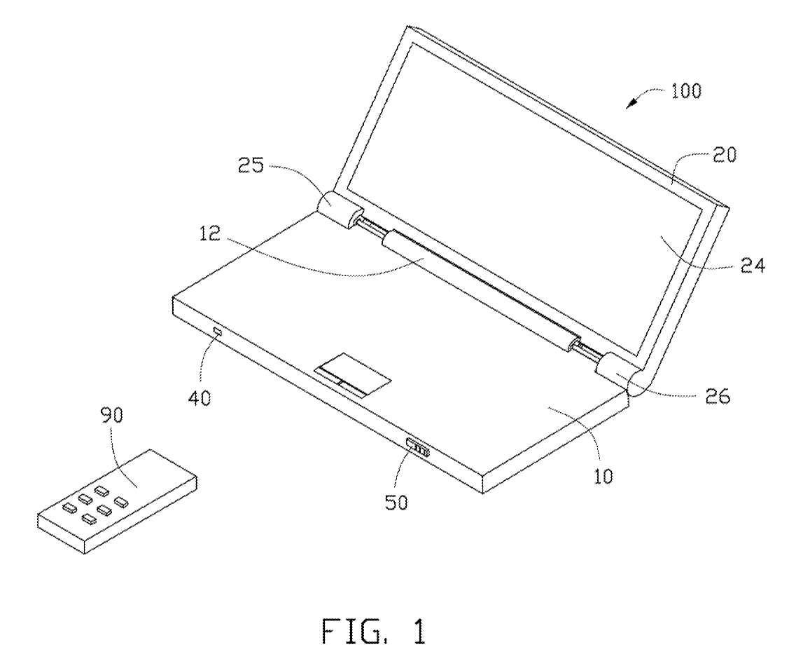

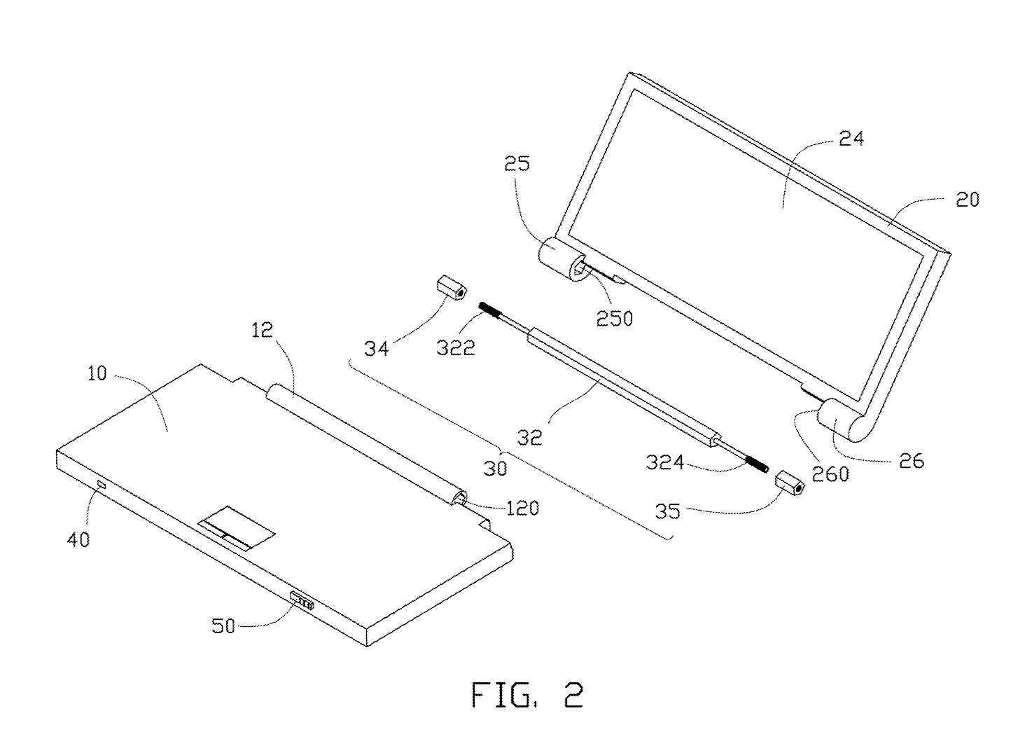

Referring to FIGS. 1 and 2, an electronic apparatus 100 in accordance with a first exemplary embodiment includes a first member 10, a second member 20 pivotably connected to the first member 10, a driving device 30, a receiving unit 40, and a control 50. The driving device 30 is adapted to rotate the second member 20 relative to the first member 10 between an open position and a closed position. In some embodiments, the electronic apparatus 100 may be a notebook computer, the first member 10 may be a main body with a plurality of keys (not shown), and the second member 20 may be a cover with a display panel 24. In a closed position, the second member 20 covers the first member 10, and the display panel 24 is protected. In an open position, the second member 20 fully deploys from the first member 10, and the display panel 24 is exposed.

A first receiving portion 12 extends from the center of a sidewall of the first member 10. The first receiving portion 12 may be cylindrical and may define a polygonal first through hole 120 formed along a longitudinal axis thereof.

A second receiving portion 25 and a third receiving portion 26 respectively extend from opposite ends of a sidewall of the second member 20. The second receiving portion 25 and the third receiving portion 26 may be cylindrical. The second receiving portion 25 defines a polygonal first blind hole 250, and the third receiving portion 26 defines a polygonal second blind hole 260 facing the first blind hole 250. The first receiving portion 12 is located between the second receiving portion 25 and the third receiving portion 26.

The driving device 30 includes a polygonal first motor 32, a polygonal first fixing part 34, and a polygonal second fixing part 35. The first motor 32 is fixed in the first receiving portion 12 through the first through hole 120, the first fixing part 34 is fixed in the second receiving portion 25 through the first blind hole 250, and the second fixing part 35 is fixed in the third receiving portion 26 through the second blind hole 260.

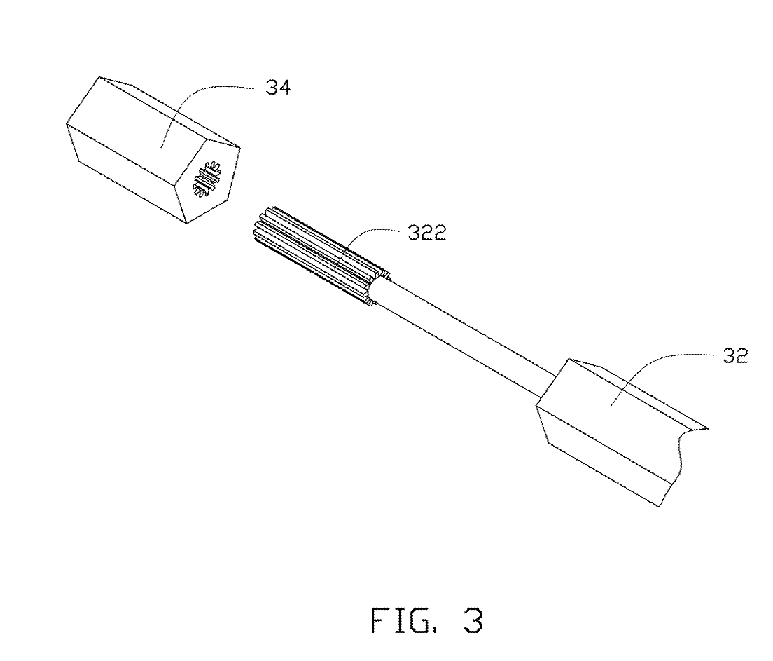

Referring to FIG. 3, opposite ends of a shaft of the first motor 32 are provided with a first internal barrel gear 322 and a second internal barrel gear 324 respectively, the first internal barrel gear 322 received in the first fixing part 34, and the second internal barrel gear 324 received in the second fixing part 35.

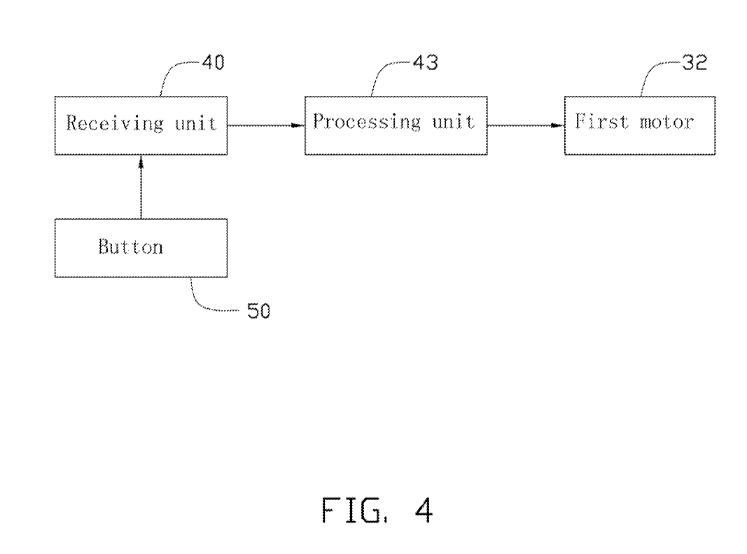

Referring to FIG. 4, the electronic apparatus 100 further includes a processing unit 43. The processing unit 43 is connected to the receiving unit 40 and the first motor 32. The receiving unit 40 receives a first control signal and a second control signal from an input device 90. The processing unit 43 activates the first motor 32 to rotate in a first direction according to the first control signal, and the first internal barrel gear 322 and the second internal barrel gear 324 respectively rotate the first fixing part 34 and the second fixing part 35, whereby the second member 20 rotates relative to the first member 10 from the closed position to the open position, and the display panel 24 is exposed.

The processing unit 43 activates the first motor 32 to rotate in a second direction opposite to the first direction according to the second control signal, the first internal barrel gear 322 and the second internal barrel gear 324 respectively rotate the first fixing part 34 and the second fixing part 35, thus the second member 20 rotates relative to the first member 10 from the open position to the closed position, and the display panel 24 is protected. In this embodiment, the input device 90 can be a remote control. Because the second member 20 is rotatable relative to the first member 10 automatically according to the signal received by the receiving unit 40 from the input device 90, operation is simplified.

The control 50 is connected to the receiving unit 40. The control 50 can be disposed on the first member 10 or the second member 20. The control 50 generates a third control signal enabling or disabling the receiving unit 40 when being depressed.

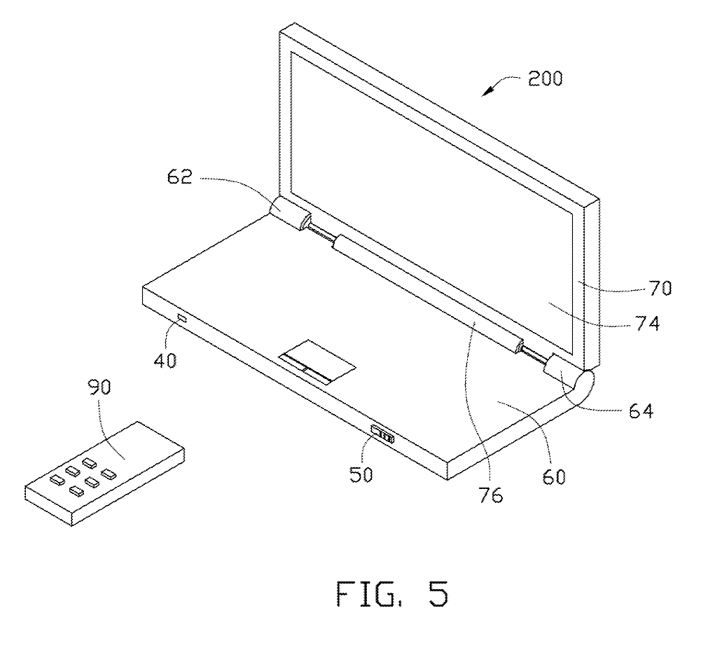

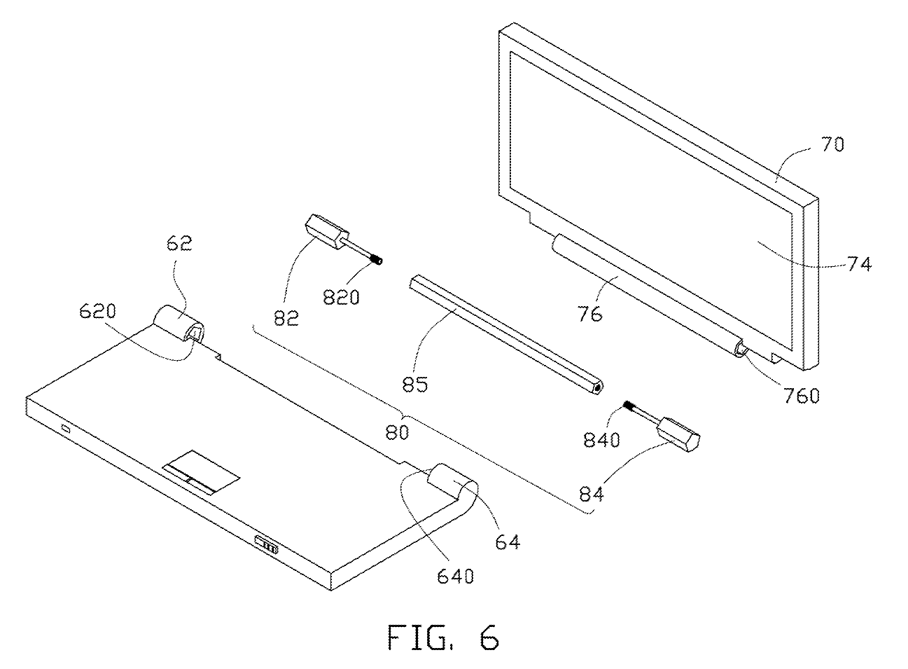

Referring to FIGS. 5 and 6, an electronic apparatus 200 in accordance with a second exemplary embodiment includes a first member 60, a second member 70, a driving device 80, the receiving unit 40, and the control 50. The driving device 80 pivotably connects the second member 70 to the first member 60, and is capable of rotating the second member 20 with respect to the first member 10. The first member 60, the second member 70, and the driving device 80 of the electronic apparatus 200 are respectively different from the first member 10, the second member 20, and the driving device 30 of the electronic apparatus 100.

A fourth receiving portion 62 and a fifth receiving portion 64 respectively extend from two ends of a sidewall of the first member 60. The fourth receiving portion 62 and the fifth receiving portion 64 are cylindrical. The fourth receiving portion 62 defines a third blind hole 620, and the fifth receiving portion 64 defines a fourth blind hole 640 opposite to the third blind hole 620.

A sixth receiving portion 76 extends from the center of a sidewall of the second member 70. The sixth receiving portion 76 is cylindrical and defines a second through hole 760. The sixth receiving portion 76 is located between the fourth receiving portion 62 and the fifth receiving portion 64.

The driving device 80 includes a second motor 82, a third motor 84, and a third fixing part 85. The second motor 82 is fixed in the fourth receiving portion 62 through the third blind hole 620. The third motor 84 is fixed in the fifth receiving portion 64 through the fourth blind hole 640, and the third fixing part 85 is fixed in the sixth receiving portion 76 through the second through hole 760.

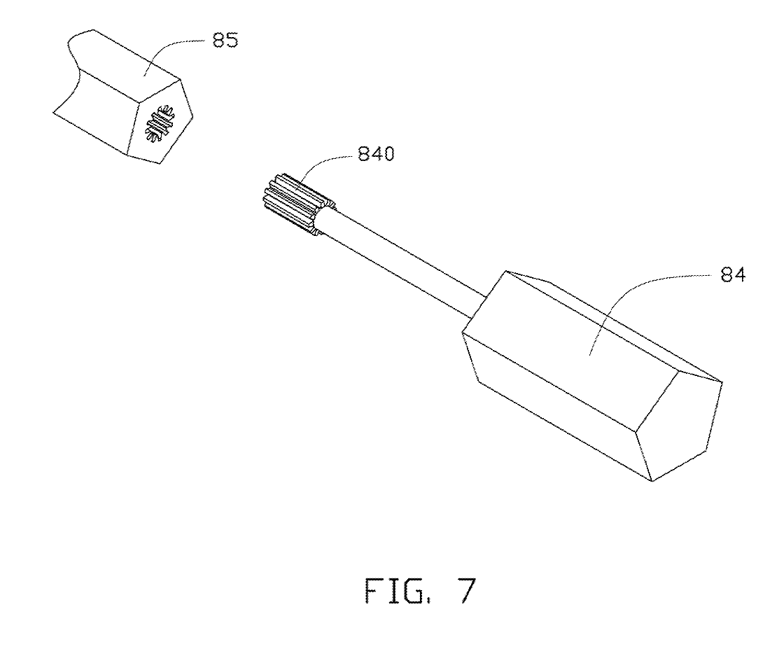

Referring to FIG. 7, the second motor 82 is provided with a third gear 820, and the third motor 84 is provided with a fourth gear 840. The third gear 820 is received in one end of the third fixing part 85, and the fourth gear 840 is received in the other end of the third fixing part 85.

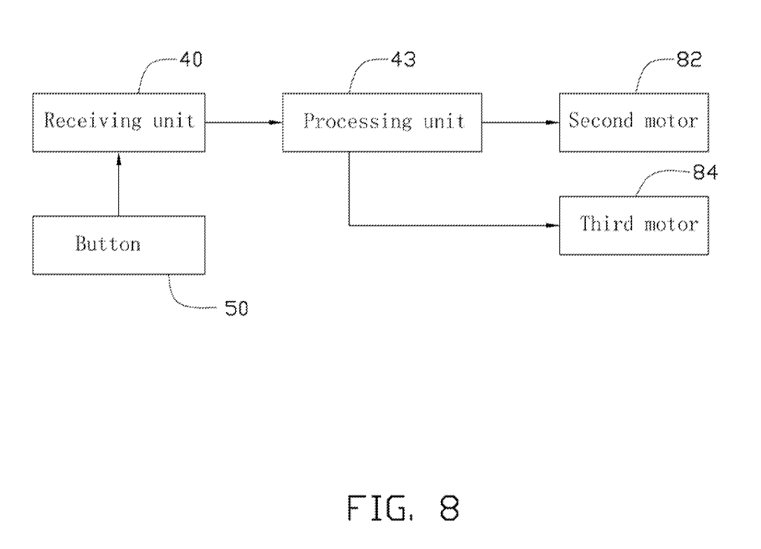

Referring to FIG. 8, the electronic apparatus 200 further includes a processing unit 43. The processing unit 43 is connected to the receiving unit 40, the second motor 82, and the third motor 84. The receiving unit 40 receives a first control signal and a second control signal from an input device 90. The processing unit 43 activates the second motor 82 and the third motor 84 to rotate in the first direction according to the first control signal, and the third gear 820 and the fourth gear 840 rotate the third fixing part 85 to rotate, whereby the second member 20 rotates relative to the first member 10 from the closed position to the open position, and the display panel 24 is exposed.

The processing unit 43 activates the second motor 82 and the third motor 84 to rotate in the second direction opposite to the first direction according to the second control signal, and the third gear 820 and the fourth gear 840 rotate the third fixing part 85, whereby the second member 20 rotates relative to the first member 10 from the open position to the closed position, and the display panel 24 is protected.

Further alternative embodiments will become apparent to those skilled in the art without departing from the spirit and scope of what is claimed. Accordingly, the present invention should be deemed not to be limited to the above detailed description, but rather only by the claims that follow and equivalents thereof.

What is claimed is:

1. An electronic apparatus comprising:
a main body;
a cover pivotably connected to the main body;
a driving device adapted to drive the cover to rotate relative to the main body between an open position and a closed position;
a receiving unit for receiving a control signal from an input device; and
a processing unit for controlling the driving device to drive the cover to rotate relative to the main body between the open position and the closed position according to the control signal.

2. The electronic apparatus as claimed in claim 1, wherein the driving device comprises a first motor, the cover is pivotably connected to the main body through the first motor, the first motor is mounted on a side of the main body, and a side of the cover is mounted on a shaft of the motor.

3. The electronic apparatus as claimed in claim 2, wherein the first motor is connected to the processing unit, a first fixing part, and a second fixing part, the first motor is fixed to the first member, the first fixing part and the second fixing part are fixed to the second member, the first motor rotates the first fixing part and the second fixing part.

4. The electronic apparatus as claimed in claim 3, wherein the first motor is provided with a first internal barrel gear and a second internal barrel gear, when the first motor is activated, the first internal barrel gear and the second internal barrel gear rotate, the first internal barrel gear is received in the first fixing part, the second internal barrel gear is received in the second fixing part.

5. The electronic apparatus as claimed in claim 3, wherein the first member is provided with a first receiving portion for receiving the first motor, the second member is provided with a second receiving portion for receiving the first fixing part and a third receiving portion for receiving the second fixing part, the first receiving portion is located between the second receiving portion and the third receiving portion.

6. The electronic apparatus as claimed in claim 5, wherein the first receiving portion defines a first through hole, the second receiving portion defines a first blind hole, the third receiving portion defines a second blind hole, the first motor is fixed in the first receiving portion through the first through hole, the first fixing part is fixed in the second receiving portion through the first blind hole, the second fixing part is fixed in the third receiving portion through the second blind hole.

7. The electronic apparatus as claimed in claim 1, wherein the driving device comprises a second motor, a third motor, and a third fixing part, the second motor and the third motor are connected to the processing unit and are fixed to the first member, the third fixing part is fixed to the second member, the second motor and the third motor rotate the third fixing part.

8. The electronic apparatus as claimed in claim 7, wherein the second motor is provided with a third gear, when the second motor is activated, the third gear rotates, the third motor is provided with a fourth gear; when the third motor is activated, the fourth gear rotates, the third gear is received in one end of the third fixing part, the fourth gear is received in the other end of the third fixing part.

9. The electronic apparatus as claimed in claim 7, wherein the first member is provided with a fourth receiving portion for receiving the second motor and a fifth receiving portion for receiving the third motor, the second member is provided with a sixth receiving portion for receiving the third fixing part, the sixth receiving portion is located between the fourth receiving portion and the fifth receiving portion.

10. The electronic apparatus as claimed in claim 9, wherein the fourth receiving portion defines a third blind hole, the fifth receiving portion defines a fourth blind hole, the sixth receiving portion defines a second through hole, the second motor is fixed in the fourth receiving portion through the third blind hole, the third motor is fixed in the fifth receiving portion through the fourth blind hole, the third fixing part is fixed in the sixth receiving portion through the second through hole.

11. An electronic apparatus comprising:
a first member;
a second member rotatable relative to the first member from a closed position at which the second member covers the first member to an open position at which the second member fully deploys from the first member,
a driving device pivotably connecting the first member to the second member;
a receiving unit for receiving a first control signal and a second control signal from an input device; and
a processing unit for controlling the driving device to rotate the second member relative to the first member from the closed position to the open position according to the first control signal, and from the open position to the closed position according to the second control signal.

12. The electronic apparatus as claimed in claim 11, further comprises a control connected to the processing unit, the control generates a third control signal for enabling or disabling the receiving unit when being depressed.

13. The electronic apparatus as claimed in claim 11, wherein the driving device comprises a first motor connected to the processing unit, a first fixing part, and a second fixing part, the first motor is fixed to the first member, the first fixing part and the second fixing part are fixed to the second member, the first motor rotates the first fixing part and the second fixing part.

14. The electronic apparatus as claimed in claim 13, wherein the first motor is provided with a first internal barrel gear and a second internal barrel gear, when the first motor is activated, the first internal barrel gear and the second internal barrel gear rotate, the first internal barrel gear is received in the first fixing part, the second internal barrel gear is received in the second fixing part.

15. The electronic apparatus as claimed in claim 13, wherein the first member is provided with a first receiving portion for receiving the first motor, the second member is provided with a second receiving portion for receiving the first fixing part and a third receiving portion for receiving the second fixing part, the first receiving portion is located between the second receiving portion and the third receiving portion.

16. The electronic apparatus as claimed in claim 15, wherein the first receiving portion defines a first through hole, the second receiving portion defines a first blind hole, the third receiving portion defines a second blind hole, the first motor is fixed in the first receiving portion through the first through hole, the first fixing part is fixed in the second receiving portion through the first blind hole, the second fixing part is fixed in the third receiving portion through the second blind hole.

17. The electronic apparatus as claimed in claim 11, wherein the driving device comprises a second motor, a third motor, and a third fixing part, the second motor and the third motor are connected to the processing unit and are fixed to the first member, the third fixing part is fixed to the second member, the second motor and the third motor rotate the third fixing part.

18. The electronic apparatus as claimed in claim 17, wherein the second motor is provided with a third gear, when the second motor is activated, the third gear rotates, the third motor is provided with a fourth gear; when the third motor is activated, the fourth gear rotates, the third gear is received in one end of the third fixing part, the fourth gear is received in the other end of the third fixing part.

19. The electronic apparatus as claimed in claim 17, wherein the first member is provided with a fourth receiving portion for receiving the second motor and a fifth receiving portion for receiving the third motor, the second member is provided with a sixth receiving portion for receiving the third fixing part, the sixth receiving portion is located between the fourth receiving portion and the fifth receiving portion.

20. The electronic apparatus as claimed in claim 19, wherein the fourth receiving portion defines a third blind hole, the fifth receiving portion defines a fourth blind hole, the sixth receiving portion defines a second through hole, the second motor is fixed in the fourth receiving portion through the third blind hole, the third motor is fixed in the fifth receiving portion through the fourth blind hole, the third fixing part is fixed in the sixth receiving portion through the second through hole.
